(19) United States
(12) Patent Application Publication
(10) Pub. No.: US 2015/0039522 A1
(43) Pub. Date: Feb. 5, 2015

(54) SYSTEM AND METHOD OF PROVIDING A VEHICLE REPAIR STATUS

(71) Applicant: STATE FARM MUTUAL AUTOMOBILE INSURANCE COMPANY, Bloomington, IL (US)

(72) Inventors: John M. Dillard, Bloomington, IL (US); Swati Pani, Bloomington, IL (US); Dustin Nunamaker, Colfax, IL (US); Surendra Karnatapu, Bloomington, IL (US); Shana K. Jevne, Normal, IL (US); Stephanie Muxfeld, Bloomington, IL (US); Jeffrey T. Graham, Bloomington, IL (US); Tom Dulee, Bloomington, IL (US); Nireesh Thiruveedula, Bloomington, IL (US)

(73) Assignee: STATE FARM MUTUAL AUTOMOBILE INSURANCE COMPANY, Bloomington, IL (US)

(21) Appl. No.: 13/955,823

(22) Filed: Jul. 31, 2013

(51) Int. Cl. G06Q 10/00

(52) U.S. Cl. CPC G06Q 10/20
USPC 705/305

(57) ABSTRACT

An instrument for compiling and monitoring a status of a vehicle repair process, wherein service repair personnel are able to modify the status of the vehicle repair process and a user is allowed to conveniently view the status of the vehicle repair process.

### TECHNICAL FIELD

This disclosure is directed to a system and method for updating and displaying a status of a repair process for a vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Damaged vehicles are frequently brought to service repair facilities to be repaired. If the damaged vehicle is insured, an insurance claim is typically associated with the vehicle. The vehicle owner is usually provided with an estimate to repair the vehicle. The repair estimate typically includes a time and cost to complete the repair. Many service repair facilities are aware that providing vehicle owners with accurate and timely status reports of the repair process help to foster a good relationship with the vehicle owner. However, providing the repair status presents a number of challenges, including who, how, and how often service repair personnel should contact the vehicle owner. Some vehicle owners may want more frequent status reports than other vehicle owners. Providing the repair status to the vehicle owner may often require service repair personnel to look up the vehicle owner's contact information, call the vehicle owner, and relay the repair status. If service repair personnel cannot reach the vehicle owner, messages must be left or additional calls may need to be made. For some service repair facilities where many employees may be involved in the repair of the vehicle, coordinating consistent communication with the vehicle owner may be very difficult because the repair work may span over several work shifts and be performed and/or reported by different service repair personnel.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To effectively provide a repair status of a damaged vehicle, even across widely disparate amounts of damage, a system and/or method for maintaining a repair process status provides service repair facilities with the ability to update the status of the vehicle repair process and provides vehicle owners with the ability to conveniently view the status of the vehicle repair process.

In one embodiment, a method of providing a status of a repair process for a vehicle includes receiving information about a vehicle repair event for the vehicle, associating a vehicle repair status with the vehicle repair event, associating an identifier with the vehicle repair event status, and storing the vehicle repair event status in a memory. The method includes receiving a request from a service facility computing device to modify the vehicle repair event status, transmitting the vehicle repair event status to the service facility computing device, receiving vehicle repair event status information from the service facility computing device; modifying the vehicle repair event status to include the vehicle repair event status information received from the service facility computing device, and storing the modified vehicle repair event status in the memory. The method further includes receiving a request to view the vehicle repair event status from a remote computing device of a user associated with the identifier, acquiring the vehicle repair event status from the memory; and transmitting the vehicle repair event status to the remote computing device for display in a non-modifiable form.

In another embodiment, a method of providing a status of a repair process for a vehicle includes receiving information about a vehicle repair process for the vehicle, associating an identifier with the vehicle repair process, and storing a form in memory, wherein the form includes the vehicle repair process, which further includes a vehicle repair event and a vehicle repair event status associated with the vehicle repair event. The method includes receiving a request from a service facility computing device to update the vehicle repair event status, the request including the identifier associated with the vehicle repair process. The method further includes acquiring the form from the memory, and transmitting the form to the service facility computing device for display, wherein the form includes a selectable item associated with the vehicle repair event status, on which selection of the selectable item, the form provides an information entry field associated with the vehicle repair event status, and wherein the information entry field is capable of receiving information via the service facility computing device. The method further includes receiving vehicle repair event status information entered via a user interface of the service facility computing device; modifying the vehicle repair event status to include the vehicle repair event status information received from the service facility computing device, and storing the modified vehicle repair event status in the memory. The method further includes receiving a request from a remote computing device of a user associated with the identifier to view the vehicle repair event status, acquiring the vehicle repair event status from the memory, and transmitting the vehicle repair event status to the remote computing device for display in a non-modifiable form.

In a further embodiment, a tangible, computer-readable medium includes stored non-transitory instructions, that when executed by one or more processors of a computer system, cause the one or more processors to receive information about a vehicle repair event for the vehicle, associate a vehicle repair status with the vehicle repair event, associate an identifier with the vehicle repair event status, store the vehicle repair event status in a memory, receive a request from a service facility computing device to modify the vehicle repair event status, transmit the vehicle repair event status to the service facility computing device, receive vehicle repair event status information from the service facility computing device, modify the vehicle repair event status to include the vehicle repair event status information received from the service facility computing device, store the modified vehicle repair event status in the memory, receive a request to view the vehicle repair event status from a remote computing device of a user associated with the identifier, acquire the vehicle repair event status from the memory, and transmit the vehicle repair event status to the remote computing device for display in a non-modifiable form.

In further accordance with any one or more of the foregoing embodiments, a system, method, and/or computer-readable medium may further include any one or more of the following preferred forms.

In one form, the method further includes receiving an image of the vehicle from the service facility computing device, and receiving a description associated with the image from the service facility computing device.

In another form, the method includes automatically transmitting advisory information to a computing device of a user associated with the vehicle in response to a modification to the vehicle repair event status, the advisory information indicating the modification to the vehicle repair event status.

In another form, the automatically transmitting advisory information includes transmitting a text message to a communication device of the user.

In another form, the automatically transmitting advisory information includes transmitting an e-mail message to the user.

In another form, receiving vehicle repair event status information from the service facility includes receiving information associated with disassembly of the vehicle.

In another form, receiving vehicle repair event status information from the service facility includes receiving information associated with structural repair of the vehicle.

In another form, receiving vehicle repair event status information from the service facility includes receiving information associated with repaired and/or replaced vehicle parts of the vehicle.

### BRIEF DESCRIPTION OF THE DRAWINGS

FIG. 1 is a flow chart illustrating compilation of an example vehicle status report;

FIG. 2 is a flow chart illustrating compilation and presentation of an example vehicle status report;

FIGS. 3A-3K are portions of information displayed on a screen during compilation of the example vehicle status report; and

FIG. 4 is an example block diagram of a system capable of supporting the monitoring of a vehicle repair process.

### DETAILED DESCRIPTION OF THE INVENTION

Although the following text sets forth a detailed description of numerous different embodiments, it should be understood that the legal scope of the description is defined by the words of the claims set forth at the end of this patent. The detailed description is to be construed as an example only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term “ ” is hereby defined to mean . . . “ ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

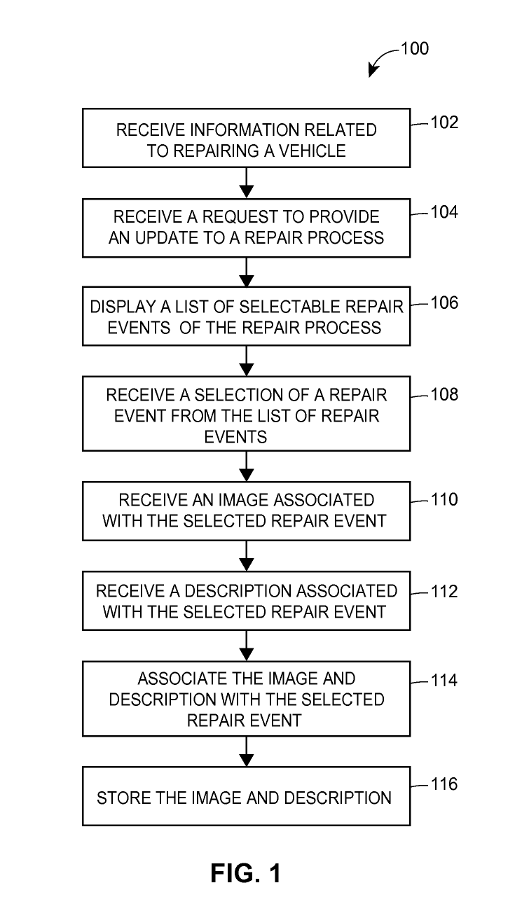

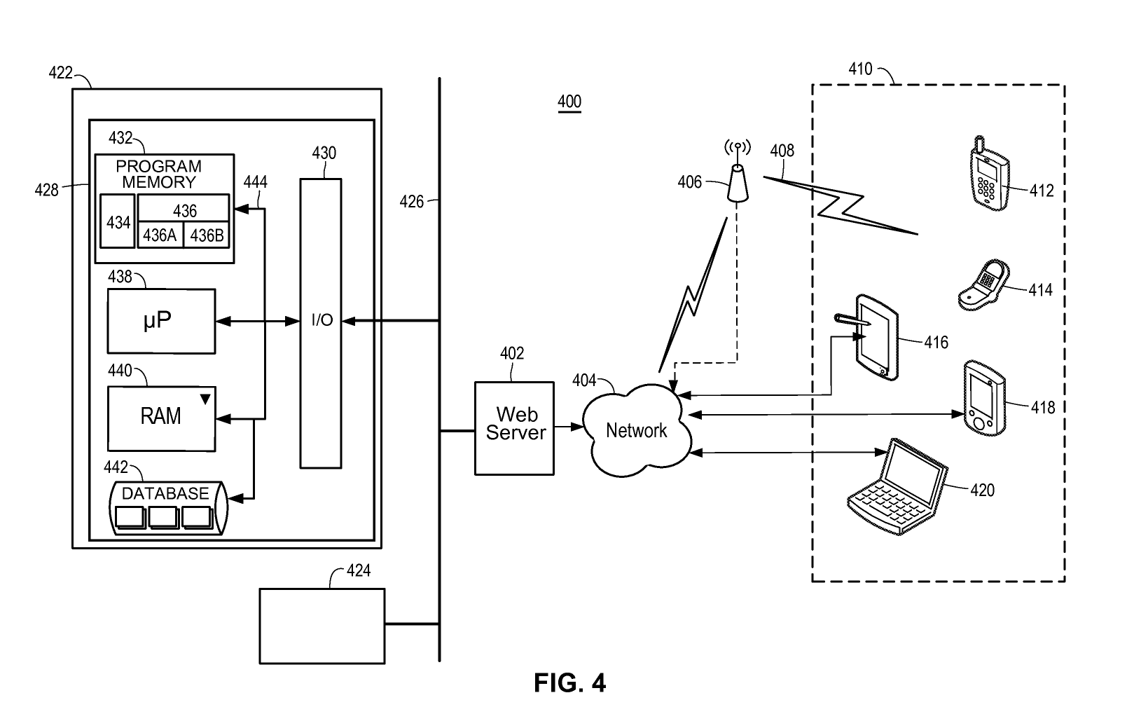

FIG. 1 is a flowchart of an example method, routine, or process 100 for monitoring and presenting a status of a vehicle repair process. The method 100 may be performed on one or more computing devices, such as the data server and computing devices in the system illustrated in FIG. 4. The example method may receive information related to repairing a damaged vehicle (block 102). The information may include a vehicle repair process for repairing the damaged vehicle. The vehicle repair process may include one or more vehicle repair events or steps. The vehicle repair process and/or vehicle repair event(s) may be associated with an identifier. The identifier facilitates association of the vehicle repair process to the damaged vehicle needing repair. The identifier may also facilitate the association of the vehicle to a user, such as the owner of the vehicle and/or an insurance agent associated with the vehicle.

The vehicle repair process may be generated or compiled based on a repair estimate of the vehicle. The repair estimate may be provided by an insurance claim adjustor or one or more service facilities capable of repairing the vehicle. The vehicle repair process may also be the result of a bidding process wherein one or more service facilities participate in a bidding process to repair the damaged vehicle. The bidding process may be administered by insurance personnel or the vehicle owner via an interview conducted in person or over the internet. The bid responses may contribute to the make-up of the vehicle repair process for a particular damaged vehicle. Example bid components may be targeted to areas such as repair cost, repair duration, repair location, etc. The bids of some or all of the participating service facilities may be utilized to create the vehicle repair process for the damaged vehicle.

The vehicle repair process may be stored at one or more memory devices within the system and each vehicle repair process may include one or more vehicle repair events or steps for repairing the vehicle. Example vehicle repair events include, and are not limited to, disassembly of the vehicle or a part of the vehicle, structural repair, repair and/or replacement of vehicle parts, and preparation for refinishing. Each vehicle repair process and/or vehicle repair event may include a corresponding status. For example, the vehicle repair event status may include a description describing the status of the vehicle repair event, such as a description of the type of repair work that was performed in relation to the vehicle repair event. The status may be integral with the vehicle repair event or process, or the status may be associated or linked with the vehicle repair event or process and stored separately on one or more memory devices of the system.

Once the vehicle repair process has been compiled, service repair personnel may utilize the vehicle repair process to repair the damaged vehicle by completing the one or more vehicle repair events of the vehicle repair process. To facilitate monitoring of the vehicle repair process, service repair personnel update the status of the vehicle repair process prior, during, and/or after completion of a particular vehicle repair event. For example, service repair personnel may request to update the vehicle repair event status (block 104). The update request may be initiated from a computing device associated with the service facility where the vehicle is being repaired. The computing device may be a stand-alone or hand-held computer that includes a user interface capable of receiving, transmitting, and displaying information such as the vehicle repair process and/or portions thereof, as well as status reports or updates to the vehicle repair process.

In response to the request entered at the service facility computing device to update the vehicle repair process, one or more corresponding vehicle repair event statuses or a portion thereof may be provided for display at the service facility computing device (block 106). A particular vehicle repair event and/or vehicle repair event status of the vehicle repair process may be selected at the user interface of the service facility computing device by service repair personnel (block 108). In response to the selection of the particular vehicle repair event and/or status, the corresponding vehicle repair event status may be provided to the service facility computing device for display. Service repair personnel may enter a description of the repair and/or modify information relating to the status of the vehicle repair event at the service facility computing device. The description may include one or more images, photographs, or drawings related to the repair work, such as “before repair” and “after repair” (blocks 110 and 112). Service repair personnel may submit the updated status information from the service facility computing device whereupon the image and/or description are associated with the corresponding vehicle repair event (block 114). The image and/or description may be stored separately or along with the vehicle repair process on the one or more memory devices communicatively coupled throughout the system (block 116).

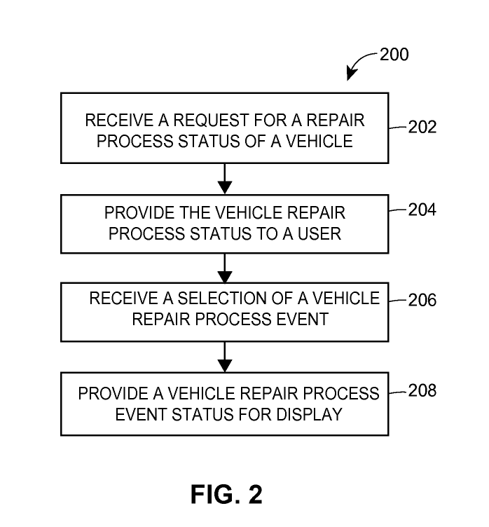

In another embodiment, an example method 200 is depicted in FIG. 2 wherein the status of the vehicle repair process is provided in a form to a user that has permission to view, but perhaps not modify, the status of the vehicle repair process. The authorized user may include the owner of the vehicle being repaired and an insurance agent associated with the vehicle. The method receives a request for the status of the vehicle repair process (block 202) from the user. The user may initiate the request from a stand-alone or hand-held computing device that includes a user interface capable of transmitting the request. In response to the request, the system provides the status of the vehicle repair process to the computing device that initiated the request (block 204). The vehicle repair status may be provided for display at the user's computing device and may include the statuses of one or more vehicle repair events of the vehicle repair process. Each vehicle repair event may include an associated selectable item. In response to a particular selectable item being selected at the user's computing device, the system receives a request for the status of the corresponding vehicle repair event (block 206), wherein information associated with the status of the corresponding vehicle repair event may be acquired by the system and provided to the user's computing device for display in a non-modifiable form (block 208). The status information may include descriptions and/or images that were submitted, e.g., uploaded, by service repair personnel that performed that particular vehicle repair event and were stored in the memory. If desired, the user may select additional selectable items to receive status information pertaining to other vehicle repair events within the vehicle repair process.

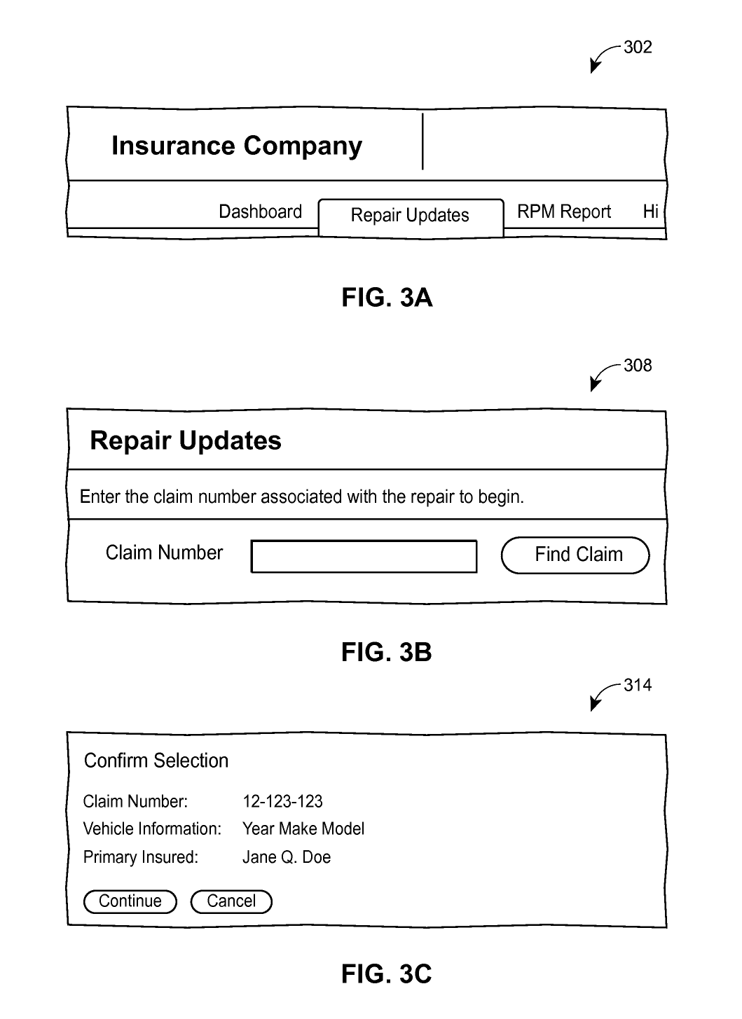

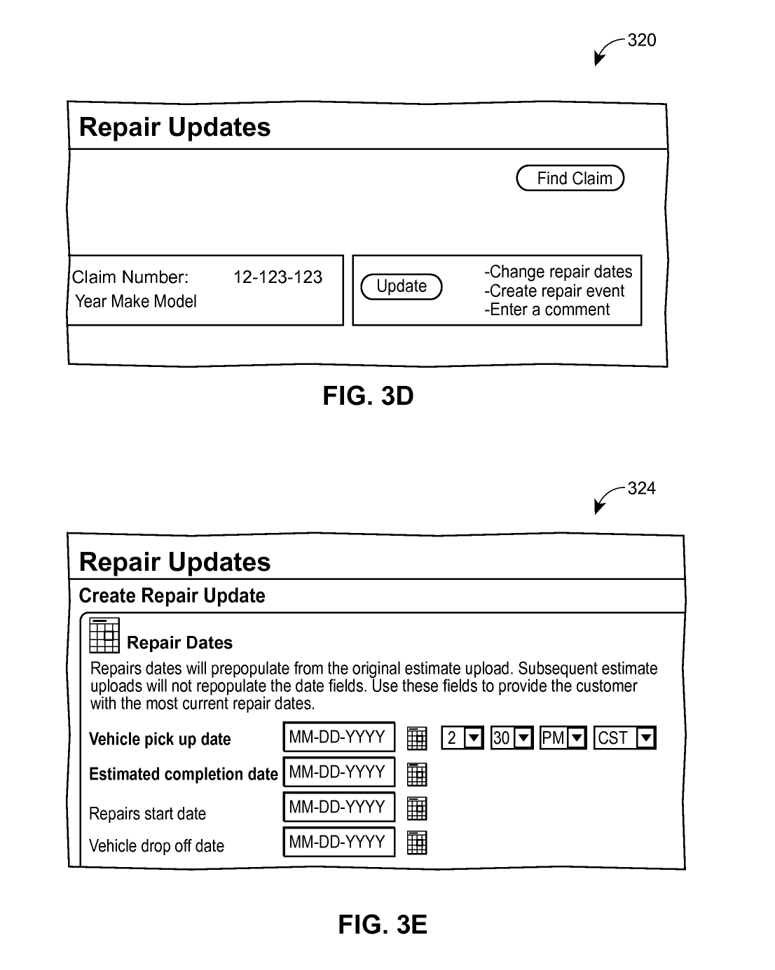

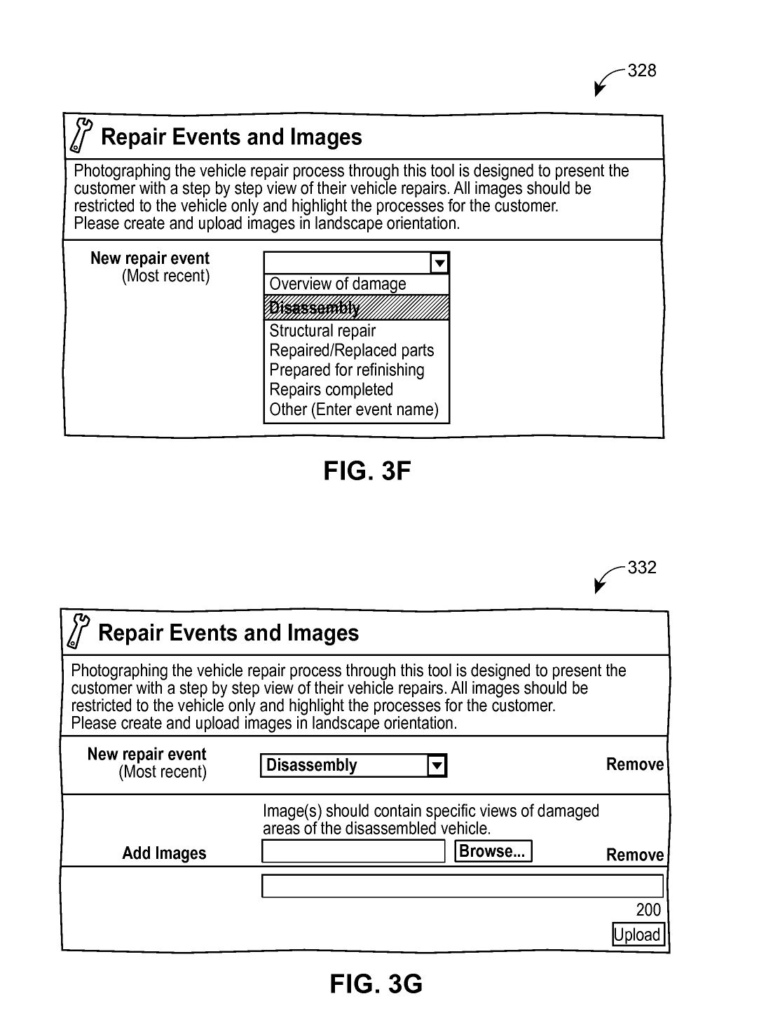

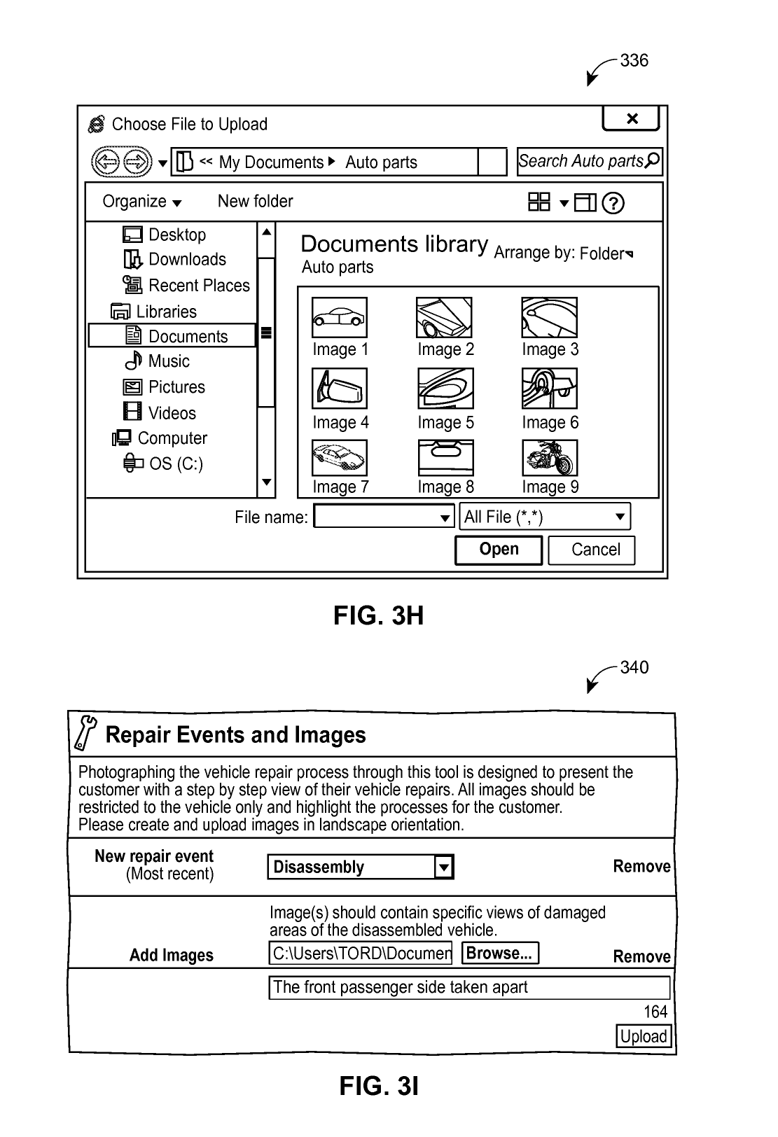

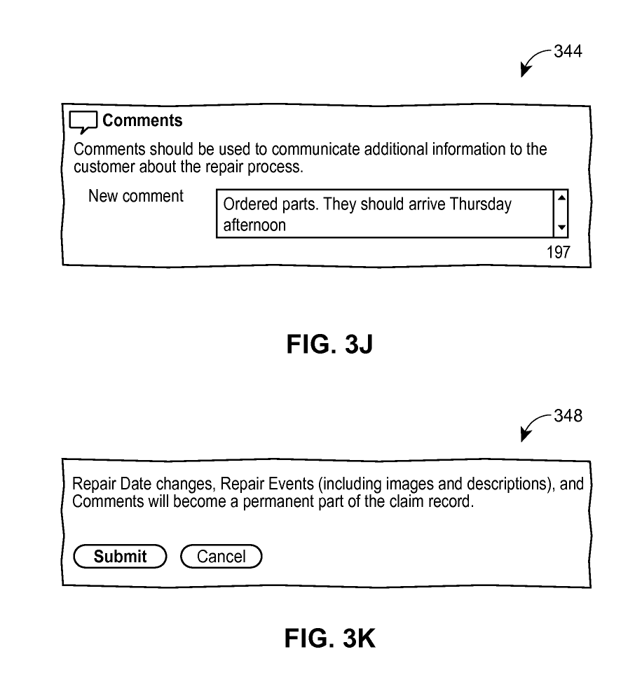

The communication between the system and the service facility, or between the system and the vehicle owner, may be accomplished by presenting information displayed on the user interface of a computing device associated with the service facility and/or the user. Some example formats of information suitable for presentation via a web browser, for example, are depicted in FIGS. 3A to 3K.

In FIG. 3A, a portion of a page 302 capable of being displayed on a user interface of the service facility's computing device is depicted. The portion 302 includes a number of selectable items, the selection of which may lead to related information maintained by an insurance company. In particular, selection of a “Repair Updates” tab may facilitate access of the service facility to a process for updating or modifying the status of a vehicle repair process.

FIG. 3B depicts a portion of a page 308 that may be provided for display at the user interface of the service facility's computing device in response to the service facility initiating a request to update the status of a vehicle repair process. The displayed portion includes a text entry location for information pertaining to the damaged vehicle. The information may be an identifier, such as insurance claim number or policy, for example, whereupon execution of the search, the vehicle repair process and/or the vehicle repair process status associated with the identifier may be acquired by the system and provided for display at the service facility computing device. In one example embodiment shown in FIG. 3C, the user may be prompted to confirm selection of the vehicle repair process and/or vehicle repair process status. Information associated with the search request may be provided for display 314 on the computing device of the service facility to ensure identification of the vehicle repair process and/or vehicle repair process status. The associated information may include the vehicle information, such as make, model, year, vehicle identification number (VIN), vehicle color, vehicle owner, primary insured, insurance policy number, insurance claim number, insurance agent name, etc.

FIG. 3D depicts a portion of a page 320 capable of being displayed at the user interface of the service facility computing device. The displayed information may include the associated identifier (e.g., insurance claim number or insurance policy number), the type of vehicle, and a number of selectable items facilitating the adjustment and/or modification of the vehicle repair process and/or vehicle repair process status. In one embodiment, service repair personnel may update or modify the vehicle repair process and/or vehicle repair process status by choosing the selectable item associated with: changing a repair date, creating a repair event, entering a comment, etc. If service repair personnel select to change a repair date, example information 324 shown in FIG. 3E may displayed at the user interface of the service facility computing device. The information may include existing dates for one or more vehicle repair events, such as, vehicle pick-up date, estimated completion date; repairs start date, and vehicle drop-off date. Service repair personnel may modify an existing date by selecting alternative dates available via one or more drop-down menus, for example. If service repair personnel choose to create, add, modify, or delete, a repair event to/from the vehicle repair process, example information 328 shown in FIG. 3F may appear on the computing device at the service facility. Several existing vehicle repair events associated with each selectable item may be available via a drop-down menu or a new vehicle repair event may be added to the vehicle repair process. Examples of existing vehicle repair events include, and are not limited to: disassembly of the vehicle, structural repair, repaired/replaced parts, prepared for refinishing, and repairs completed.

Service repair personnel are able to update the status of the vehicle repair process by providing status information associated with a particular vehicle repair event. If service repair personnel choose to enter additional information such as a description or comment, example information 332 shown in FIG. 3G may appear on the user interface of the service facility computing device. The example information 332 may include a drop-down menu having one or more selectable items respectively associated with one or more vehicle repair events. A text entry box may also be provided for receiving status information to be associated with the particular service repair event. In one embodiment, service repair personnel may update the vehicle repair event status of a vehicle repair event by adding one or more images, photographs, and/or drawings of the vehicle during the repair process. The images of the vehicle may be stored at the service facility computing device or stored on another device, e.g., camera, memory device; that is capable of being communicatively coupled to the service facility computing device. As shown in FIG. 3H, service repair personnel may select one or more images 336 associated with the vehicle repair process that reside at the memory device of the service facility computing device. When one or more images are selected, a commentary window 340 shown in FIG. 31 may appear on the user interface of the service facility computing device, wherein service repair personnel may provide comments associated with the one or more images. Additionally, service repair personnel may provide general comments associated with the vehicle repair process. In FIG. 3J, a text entry box 344 may be presented on the user interface of the service facility computing device wherein text may be entered by service repair personnel.

In FIG. 3K, upon completion of the insertion of information, service repair personnel may select to submit the status update information 348 for uploading to the system, where it may be stored at one or more memory devices communicably coupled to the system and associated with the vehicle and/or vehicle repair process.

Similar presentations as depicted in FIGS. 3A-3K may be utilized to provide the status of the vehicle process to a user such as the vehicle owner and/or insurance personnel, for example. In particular, in response to the vehicle owner's request via a computing device for the status of the vehicle repair process, the system may provide the vehicle repair process and/or vehicle repair process status to the requesting computing device. The status information may be provided in a non-modifiable form capable of being viewed on the user interface of the requesting computing device. The status information may include descriptions and/or images associated with vehicle repair events that were provided by service repair personnel that performed the repairs on the vehicle. Additionally or alternatively, the system may transmit messages to the user related to the status of the repair process. The messages may include an automated phone call or text message including information about the vehicle repair process status. The messages may be programmed to be automatically transmitted at the completion of an update to the vehicle repair process status. Additionally, the messages may be scheduled to occur on a periodic basis and to include the vehicle repair process status information and/or a link to the vehicle repair process status information provided by a database and/or website.

FIG. 4 illustrates various aspects of the example system architecture 400 capable of implementing a method for updating a vehicle repair process status. The high-level architecture includes both hardware and software applications, as well as various data communication channels for communicating data between the various hardware and software components. The vehicle repair processes, vehicle repair process events, and/or vehicle repair process statuses may be communicated via a web server 402 amongst a data server 422 and one or more web-enabled computing devices 410 connected over a network 404. The data server 422 may be connected to the web server 402 via a network bus 426 and may implement the processes described above for compiling and presenting a status of a vehicle repair process. The web server 402 may be implemented in one of several known configurations via one or more servers configured to process web-based traffic via the network 404 and may include load balancing, edge caching, proxy services, authentication services, etc.

The data server 422 includes a controller 428 having a program memory 432, a microcontroller or a microprocessor (μP) 438, a random-access memory (RAM) 440, and an input/output (I/O) circuit 430, all of which are operatively interconnected via an address/data bus 444. The vehicle repair processes, vehicle repair process events, and/or vehicle repair process statuses may be stored in the memory of the controller 428. It should be appreciated that even though FIG. 4 depicts only one microprocessor 438, the controller 428 may include multiple microprocessors 438. Additionally, although the I/O circuit 430 is depicted as a single block, the I/O circuit 430 may include a number of different types of I/O circuits (not depicted), including but not limited to, additional load balancing equipment, firewalls, etc. The data server 422 may also include specific routines or modules to render the data into an image for display by a client computer (not depicted) or any of the computing devices 410 via the web server 402.

The memory 432 of the controller 428 may include multiple RAMs 434 and multiple program memories 436, 436A, 436B storing one or more corresponding server application modules, according to the particular configuration of the controller 428. The RAM(s) 434, 440 and the program memories 436, 436A, 436B may be implemented in a known form of computer storage media, including but not limited to, semiconductor memories, magnetically readable memories, and/or optically readable memories, for example, but does not include transitory media such as carrier waves.

The controller 428 may also include, or otherwise be communicatively connected to, a database or other data storage mechanism, e.g., one or more hard disk drives, optical storage drives, solid state storage devices, etc. The database may include information such as the vehicle repair processes, vehicle repair process events, and/or vehicle repair process statuses. The database may be internal to the controller, i.e., database 442, and operatively coupled to the address/data bus 444 and/or external to the controller, i.e., database 424, and operatively coupled to the controller 428 and the network 404 via the network bus 426. Any one or more of the databases 424, 442 may also include vehicle owner/insured profile information for use in monitoring a vehicle repair process status.

The computing devices 410 may include by way of example, a smart-phone 412, a web-enabled mobile phone 414, a tablet computer 416, a personal digital assistant (PDA) 418, and a laptop/desktop computer 420. In some instances, the web enabled devices 410 may communicate with the network 404 via wireless signals 408 and, in some configurations, may communicate with the network 404 via an intervening wireless or wired device 406, which may be a wireless router, a wireless repeater, a base transceiver station of a mobile telephony provider, etc. In most cases, the network 404 may be the internet using an internet protocol, but other networks may also be used.

To the extent that any meaning or definition of a term in this document conflicts with any meaning or definition of the same term in a document incorporated by reference, the meaning or definition assigned to that term in this document shall govern. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of providing a status of a repair process including one or more repair events for a vehicle, the method comprising:
receiving a plurality of repair estimates for a vehicle, the plurality of repair estimates including a repair estimate from a plurality of service facilities;
compiling a vehicle repair process from the plurality of repair estimates, the vehicle repair process including a plurality of vehicle repair events;
receiving information about a particular vehicle repair event for the vehicle;
associating, by one or more processors, a particular vehicle repair event status with the information about the particular vehicle repair event;
associating, by the one or more processors, an identifier with the particular vehicle repair event status;
storing, by the one or more processors, the particular vehicle repair event status in a memory;
receiving, by the one or more processors, a request from a service facility computing device to modify the particular vehicle repair event status;
transmitting, by the one or more processors, the particular vehicle repair event status to the service facility computing device;
receiving, by the one or more processors, vehicle repair event status information associated with the particular vehicle repair event status from the service facility computing device;
modifying, by the one or more processors, the particular vehicle repair event status to include the vehicle repair event status information received from the service facility computing device;
storing, by the one or more processors, the modified particular vehicle repair event status in the memory;
receiving, by the one or more processors, a request from a remote computing device of an owner of the vehicle to view the status of the repair process;
acquiring, by the one or more processors, the particular vehicle repair event status from the memory;
transmitting, by the one or more processors, the particular vehicle repair event status to the remote computing device; and
displaying, by the one or more processors, the particular vehicle repair event status in a non-modifiable form on the remote computing device.

2. The method of claim 1, wherein receiving vehicle repair event status information includes:
receiving an image of the vehicle from the service facility computing device; and
receiving a description associated with the image from the service facility computing device.

3. The method of claim 1, further including:
automatically transmitting, by the one or more processors, advisory information to the remote computing device of the owner of the vehicle in response to a modification to the particular vehicle repair event status, the advisory information indicating the modification to the particular vehicle repair event status.

4. The method of claim 3, wherein automatically transmitting advisory information includes transmitting a text message to the remote computing device of the owner of the vehicle.

5. The method of claim 3, wherein automatically transmitting advisory information includes transmitting an e-mail message to the remote computing device of the owner of the vehicle.

6. The method of claim 1, wherein receiving vehicle repair event status information from the service facility includes receiving information associated with disassembly of the vehicle.

7. The method of claim 1, wherein receiving vehicle repair event status information from the service facility includes receiving information associated with structural repair of the vehicle.

8. The method of claim 1, wherein receiving vehicle repair event status information from the service facility includes receiving information associated with repaired and/or replaced vehicle parts of the vehicle.

9. A method of providing a status of a repair process including one or more repair events for a vehicle, the method comprising:
receiving a plurality of repair estimates for a vehicle, the plurality of repair estimates including a repair estimate from a plurality of service facilities;
compiling a vehicle repair process from the plurality of repair estimates;
receiving, by one or more processors, information about the vehicle repair process for the vehicle;
associating, by the one or more processors, an identifier with the vehicle repair process;
storing, by the one or more processors, a form including the vehicle repair process in a memory, the vehicle repair process including a vehicle repair event and a vehicle repair event status associated with the vehicle repair event;
receiving, by the one or more processors, a request from a service facility computing device to update the vehicle repair event status, the request including the identifier associated with the vehicle repair process;
acquiring, by the one or more processors, the form from the memory;
transmitting, by the one or more processors, the form to the service facility computing device for display, the form including a selectable item associated with the vehicle repair event status, and upon selection of the selectable item, the form provides an information entry field associated with the vehicle repair event status, the information entry field capable of receiving information via the service facility computing device;
displaying, by the one or more processors, the form on the service facility computing device;
receiving, by the one or more processors, vehicle repair event status information entered via the form displayed on the service facility computing device;
modifying, by the one or more processors, the vehicle repair event status to include the vehicle repair event status information received from the service facility computing device;
storing, by the one or more processors, the modified vehicle repair event status in the memory;
receiving, by the one or more processors, a request from a remote computing device of an owner of the vehicle to view the vehicle repair event status;
acquiring, by the one or more processors, the vehicle repair event status from the memory;
transmitting, by the one or more processors, the vehicle repair event status to the remote computing device; and
displaying, by the one or more processors, the vehicle repair event status in a non-modifiable form on the remote computing device.

10. The method of claim 9, wherein receiving vehicle repair event status information includes:
receiving an image of the vehicle from the service facility computing device; and
receiving a description associated with the image from the service facility computing device.

11. The method of claim 9, further including:
automatically transmitting, by the one or more processors, advisory information to the remote computing device of the owner in response to a modification to the vehicle repair event status, the advisory information indicating the modification to the vehicle repair event status.

12. The method of claim 11, wherein automatically transmitting advisory information includes transmitting a text message to the remote computing device of the owner of the vehicle.

13. The method of claim 11, wherein automatically transmitting advisory information includes transmitting an e-mail message to the remote computing device of the owner of the vehicle.

14. The method of claim 9, wherein receiving vehicle repair event status information from the service facility computing device includes receiving information associated with disassembly of the vehicle.

15. The method of claim 9, wherein receiving vehicle repair event status information from the service facility computing device includes receiving information associated with structural repair of the vehicle.

16. The method of claim 9, wherein receiving vehicle repair event status information from the service facility computing device includes receiving information associated with repaired and/or replaced vehicle parts of the vehicle.

17. A tangible, non-transitory computer-readable medium storing non-transitory instructions that when executed by one or more processors of a computer system cause the one or more processors to:
receive a plurality of repair estimates for a vehicle, the plurality of repair estimates including a repair estimate from a plurality of service facilities;
compile a vehicle repair process from the plurality of repair estimates, the vehicle repair process including a plurality of vehicle repair events;
receive information about a particular vehicle repair event for the vehicle;
associate a particular vehicle repair event status with the particular vehicle repair event;
associate an identifier with the particular vehicle repair event status;
store the particular vehicle repair event status in a memory;
receive a request from a service facility computing device to modify the particular vehicle repair event status;
transmit the particular vehicle repair event status to the service facility computing device;
display the particular vehicle repair event status on the service facility computing device;
receive vehicle repair event status information associated with the particular vehicle repair event status from the service facility computing device;
modify the particular vehicle repair event status to include the vehicle repair event status information received from the service facility computing device;
store the modified particular vehicle repair event status in the memory;
receive a request from a remote computing device of an owner of the vehicle to view the status of the repair process;
acquire the particular vehicle repair event status from the memory;
transmit the particular vehicle repair event status to the remote computing device; and
display the particular vehicle repair event status on the remote computing device in a non-modifiable form.

18. The tangible, non-transitory computer-readable medium of claim 17, including a further non-transitory instruction that when executed by one or more processors of the computer system cause the one or more processors to automatically transmit advisory information to another remote computing device of the owner of the vehicle in response to a modification to the particular vehicle repair event status, the advisory information indicating the modification to the particular vehicle repair event status.

19. The method of claim 1, wherein the owner of the vehicle is an agent of the owner of the vehicle.

20. The method of claim 9, wherein the owner of the vehicle is an agent of the owner of the vehicle.
